(19) United States
(12) Patent Application Publication
(10) Pub. No.: US 2015/0333408 A1
(43) Pub. Date: Nov. 19, 2015

(54) ANTENNA DEVICE AND WIRELESS TRANSMISSION DEVICE

(71) Applicant: PANASONIC CORPORATION, Osaka (JP)

(72) Inventors: Takeshi OHNO, Osaka (JP); Sotaro SHINKAI, Osaka (JP)

(21) Appl. No.: 14/652,140

(22) PCT Filed: Jan. 31, 2014
(86) PCT No.: PCT/JP2014/000507

§ 371 Date: Jun. 15, 2015

(30) Foreign Application Priority Data
Feb. 7, 2013 (JP) 2013-021885

(51) Int. Cl. H01Q 9/16; H01Q 19/06; H01Q 9/06

(52) U.S. Cl. CPC H01Q 9/16; H01Q 9/065; H01Q 19/06

(57) ABSTRACT

In each parasitic element array, parasitic elements, each having a strip shape substantially parallel to a longitudinal direction of a dipole antenna, are formed at predetermined intervals. The parasitic element arrays are arranged such that a plurality of gaps are formed to propagate a radio wave from the dipole antenna, and that a center axis of the dipole antenna and a center axis of a parasitic element group composed of a plurality of parasitic element arrays do not overlap each other, where the center axis of the dipole antenna extends in a wave-guiding direction of a radio frequency signal from a center of the longitudinal direction of the dipole antenna, and the center axis of the parasitic element group extends in the wave-guiding direction of the radio frequency signal from a center of the parasitic element group in the longitudinal direction of the dipole antenna.

### TECHNICAL FIELD

The present disclosure relates to an antenna device including a feed element and a plurality of parasitic elements, and a wireless communication device using the antenna device.

### BACKGROUND ART

As a conventional art, an endfire antenna is known and the endfire antenna has a high gain for radio waves in an extremely radio frequency band such as the millimeter wave band. It was difficult to apply high gain antennas to mobile devices and the like because beam angle ranges of high gain antennas are narrow. To apply the high gain antennas to mobile equipment and the like, beam forming in the endfire antenna is necessary.

As a general endfire antenna, a slot antenna is known and the slot antenna has a slot, which is formed at an edge of a ground conductor formed on a front surface of a dielectric substrate to be perpendicular to the edge, and a feed line formed on a back surface of the dielectric substrate to intersect the slot. The feed line is electromagnetically coupled to the slot, and a radio frequency signal transmitted through the feed line excites the slot. At this time, an electric field generated in the slot is guided along the slot in an edge direction of the dielectric substrate, and is radiated in a wave-guiding direction.

Accordingly, if it is required to change a beam direction on a horizontal plane of the dielectric substrate, a waveguide must be disposed in the beam direction.

As a prior art for controlling beam of diversity system and the like by using parasitic elements and the like, a structure is disclosed in which waveguides are arranged in a plurality of directions to form a printed dipole antenna having a bidirectional directivity in a horizontal direction of a substrate (for example, PTL1 of the Patent Literature).

### CITATION LIST

### Patent Literature

PTL 1: Unexamined Japanese Patent Publication No. H7-245525

### SUMMARY OF THE INVENTION

An antenna device of the present disclosure includes a dielectric substrate having a first surface and a second surface, a first dipole antenna including a first dipole element formed on the first surface of the dielectric substrate and connected to a first feed line, and a second dipole element formed on the second surface of the dielectric substrate and connected to a ground conductor, and a first parasitic element group including a plurality of first parasitic element arrays, each of the first parasitic element arrays including a plurality of first parasitic elements formed on the first surface of the dielectric substrate. Each of the plurality of first parasitic elements has a strip shape substantially parallel to a longitudinal direction of the first dipole antenna, and is electromagnetically coupled to another of the plurality of first parasitic elements, the plurality of first parasitic element arrays are arranged substantially parallel to one another, and a gap is formed between each adjacent two of the plurality of first parasitic element arrays, and a center axis of the first dipole antenna and a center axis of the first parasitic element group are disposed so as not to overlap, the center axis of the first dipole antenna is an axis which extends a center of an electrical length of the first dipole antenna to a wave-guiding direction of a radio frequency signal, and the center axis of the first parasitic element group is an axis which extends a center of a longitudinal direction of the first dipole antenna in the first parasitic element group to a wave-guiding direction of the radio frequency signal.

The antenna device according to the present disclosure makes it possible to control beam in a high gain endfire antenna structure.

### BRIEF DESCRIPTION OF DRAWINGS

FIG. 1 is a front view of antenna device 100 according to a first exemplary embodiment.

FIG. 2 is a back view of antenna device 100 according to the first exemplary embodiment.

FIG. 3 is a graph showing a radiation pattern on a ZX plane, when a number of parasitic element arrays 107 is set to 6 and a number of parasitic elements 106 contained in each of parasitic element arrays 107 is set to 16 in antenna device 100 shown in FIG. 1.

FIG. 4 is a front view of antenna device 400 according to a modified example of the first exemplary embodiment.

FIG. 5 is a back view of antenna device 400 according to the modified example of the first exemplary embodiment.

FIG. 6 is a graph showing a radiation pattern on a ZX plane, when a number of parasitic element arrays 407 is set to 6 and a number of parasitic elements 406 contained in each of parasitic element arrays 407 is set to 16 in antenna device 400 shown in FIG. 4.

FIG. 7 is a graph showing a change of a radiation pattern on the ZX plane, when changing a length of dipole element 105 in antenna device 100 shown in FIG. 1.

FIG. 8 is a front view of antenna device 800 according to a second exemplary embodiment.

FIG. 9 is a back view of antenna device 800 according to the second exemplary embodiment.

FIG. 10 is a graph showing a radiation pattern on the ZX plane, when fed to a first dipole antenna in antenna device 800 shown in FIG. 8.

FIG. 11 is a graph showing a radiation pattern on the ZX plane, when fed to a second dipole antenna in antenna device 800 shown in FIG. 8.

FIG. 12 is a front view of antenna device 1200 according to a third exemplary embodiment.

FIG. 13 is a graph showing a radiation pattern on the ZX plane, when a phase difference between feed to a first dipole antenna and feed to a second dipole antenna is ±180 degrees in antenna device 1200 shown in FIG. 12.

FIG. 14 is a graph showing a radiation pattern on the ZX plane, when the phase difference between feed to the first dipole antenna and feed to the second dipole antenna is fixed to 90 degrees in antenna device 1200 shown in FIG. 12.

FIG. 15 is a front view of wireless communication device 1500 according to a fourth exemplary embodiment.

FIG. 16 is a front view of wireless communication device 1600 according to the fourth exemplary embodiment.

### DESCRIPTION OF EMBODIMENTS

Hereinafter, exemplary embodiments will be described in detail with reference to the accompanying drawings as appropriate. However, unnecessarily detailed description may occasionally be omitted. For example, detailed description of well-known matters and redundant description of substantially the same configurations may occasionally be omitted. This is to avoid the following description from becoming unnecessarily redundant, and to help persons skilled in the art to easily understand the present disclosure.

Also, it should be noted that the following description and the accompanying drawings are provided to allow any person skilled in the art to fully understand the present disclosure, and that it is not intended to limit the subject matter described in the claims by the following description and the accompanying drawings.

### First Exemplary Embodiment

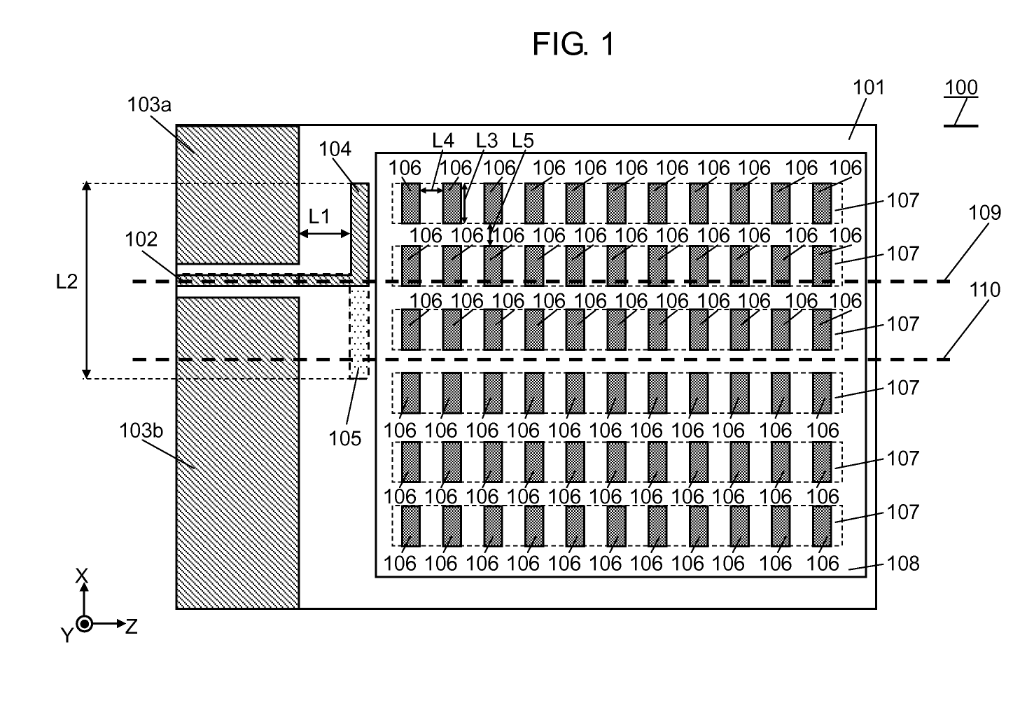

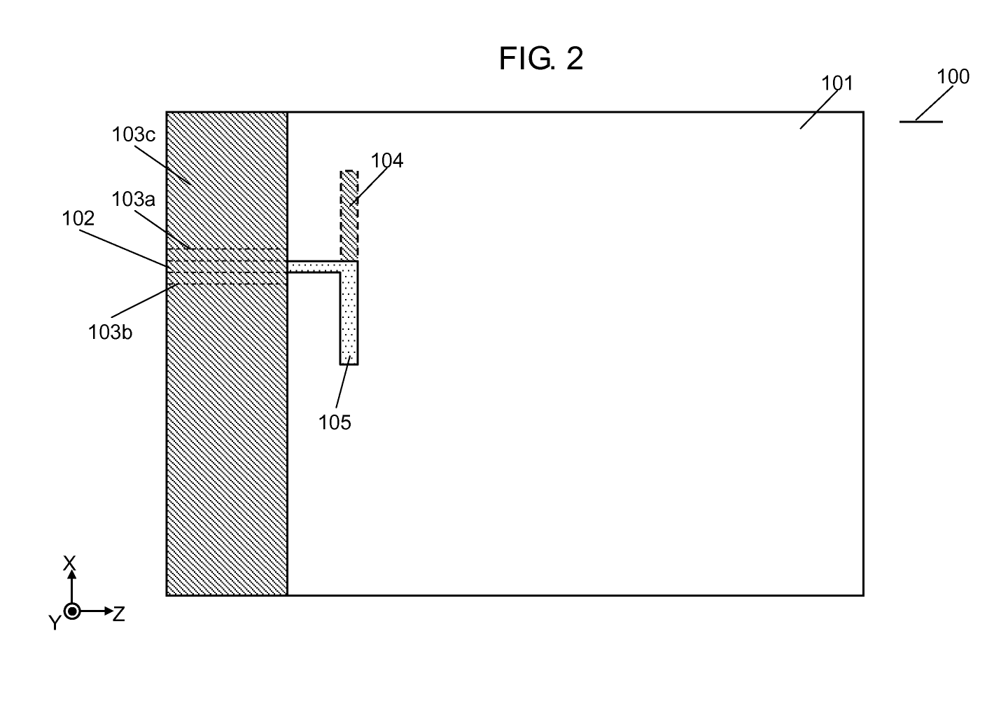

FIG. 1 is a front view of antenna device 100 according to the present exemplary embodiment, and FIG. 2 is a back view of antenna device 100 shown in FIG. 1 and is the view from the front surface side. Antenna device 100 according to the present exemplary embodiment is an endfire antenna for a wireless communication device that performs wireless communication in a radio frequency band such as the millimeter wave band.

Antenna device 100 shown in FIG. 1 and FIG. 2 includes dielectric substrate 101, feed line 102, ground conductors 103a, 103b and 103c, dipole elements 104 and 105, and six parasitic element arrays 107 each including eleven parasitic elements 106. Parasitic element group 108 is configured to include six parasitic element arrays 107. It is noted that a XYZ coordinate system is defined as shown in FIG. 1 in the present exemplary embodiment, the following exemplary embodiments and modified examples. In FIG. 1, a rightward direction is defined as a +Z-axis direction, and a upward direction is defined as a +X-axis direction. The opposite direction to the +X-axis direction is defined as a −X-axis direction, and the opposite direction to the +Z-axis direction is defined as a −Z-axis direction. Also, a frontward direction perpendicular to the drawing sheet surface of FIG. 1 is defined as a +Y-axis direction, and the opposite direction to the +Y-axis direction is defined as a −Y-axis direction.

Referring to FIG. 1, dielectric substrate 101 is a glass epoxy substrate, for example. In addition, ground conductors 103a and 103b, feed line 102, dipole element 104, parasitic elements 106, parasitic element arrays 107 and parasitic element group 108 are formed on a front surface of dielectric substrate 101. Ground conductor 103c and dipole element 105 are formed on a back surface of dielectric substrate 101. Ground conductor 103c is formed on a left end part of dielectric substrate 101 shown in FIG. 1 and FIG. 2. Feed line 102 is formed to oppose to ground conductor 103c and to extend in the +Z-axis direction from the left end part of dielectric substrate 101. Ground conductors 103a and 103b are formed on both sides of feed line 102, respectively, so as to oppose to ground conductor 103c. There is a predetermined interval between ground conductors 103a and feed line 102 and there is a predetermined interval between ground conductors 103b and feed line 102. Ground conductors 103a, 103b and 103c are electrically connected to one another.

Referring to FIG. 1 and FIG. 2, ground conductors 103a, 103b and 103c and feed line 102 configure a grounded coplanar waveguide used as a power supply line.

Feed line 102 is a supply line to supply power to dipole elements 104 and 105. A radio frequency signal is supplied to the grounded coplanar waveguide from a radio frequency circuit which will be described later.

The two elements, dipole element 104 and dipole element 105, operate as a single dipole antenna. In the present exemplary embodiment, dipole element 104 is formed on the front surface of dielectric substrate 101, and dipole element 105 is formed on the back surface of dielectric substrate 101. Dipole element 104 is connected to feed line 102, extends predetermined distance L1 in the +Z-axis direction, and bends at a right angle to further extend in the +X-axis direction. Dipole element 105 is connected to ground conductor 103c, extends predetermined distance L1 in the +Z-axis direction, and bends at a right angle to further extend a same length as dipole element 104 in the −X-axis direction. If dipole element 104 and dipole element 105 are projected on a same plane, positions of the two elements on the X-axis are on the same straight line to form a single straight line shape having electrical length L2. Dipole element 104 and dipole element 105 are connected in opposite phases to operate as a single dipole antenna. Electrical length L2 may be preferably about a half (2/2) a wavelength λ of a radio wave transmitted and received by antenna device 100.

When a radio frequency signal is supplied to feed line 102 and ground conductors 103a, 103b and 103c which configure the grounded coplanar waveguide, dipole element 104 and dipole element 105 operate an excitation.

Referring to FIG. 1, each of six parasitic element arrays 107 includes eleven parasitic elements 106.

Each of parasitic elements 106 is formed on the +Z-axis direction side of dipole element 104 on dielectric substrate 101 so that its longitudinal direction is substantially parallel to the dipole element 104 on the X-axis. In FIG. 1, all parasitic elements 106 have the same length L3 in their longitudinal directions. Length L3 may preferably be equal to or shorter than an eighth (λ/8) the wavelength λ of the radio wave transmitted and received by antenna device 100.

In addition, six parasitic elements are aligned on the X-axis and eleven parasitic elements are aligned on the Z-axis. Each adjacent two parasitic elements 106 on the Z-axis are at the same position on the X-axis. A collection of eleven parasitic elements 106 that are at the same position on the X-axis configures one parasitic element array 107. Each adjacent two parasitic elements 106 in parasitic element array 107, that is, each adjacent two parasitic elements 106 on the Z-axis, are apart from each other by interval L4. Interval L4 is equal to or shorter than an eighth (λ/8) the wavelength λ of the radio wave transmitted and received by antenna device 100.

With this configuration, electric walls are generated at both sides (in the +X-axis direction and the −X-axis direction) of each parasitic element array 107. By disposing the plurality of parasitic element arrays 107 on the X-axis, a gap having length L5 between each adjacent two parasitic element arrays 107 on the X-axis becomes a dummy slot antenna. Specifically, five dummy slot antennas are formed. Accordingly, an electromagnetic field primarily radiated by excitation of dipole element 104 and dipole element 105 is guided in the dummy slots in the +Z-axis direction, and radiated from the right end of dielectric substrate 101 in the +Z-axis direction, which is the directivity direction of antenna device 100. The +Z-axis direction is also called a wave-guiding direction.

In the above description, a radio wave is transmitted from antenna device 100. When antenna device 100 receives a radio wave, an electromagnetic wave coming from the +Z-axis direction transmits a radio frequency signal to the radio frequency circuit through parasitic element arrays 107 and dipole elements 104 and 105.

In antenna device 100 shown in FIG. 1, center axis 109 extends in the +Z-axis direction from a center on the X-axis of electrical length L2 of the dipole antenna configured by dipole element 104 and dipole element 105. Center axis 110 extends in the +Z-axis direction from a center on the X-axis between an end in the +X-axis direction of parasitic element group 108 and an end in the −X-axis direction of parasitic element group 108. Center axis 109 is shifted from center axis 110 in the +X-axis direction.

In other words, a positional relationship between center axis 109 of the dipole antenna and center axis 110 of parasitic element group 108 is a different position on the X-axis.

When dipole element 104 and dipole element 105 are regarded as a single dipole antenna, center axis 109 of the dipole antenna is an axis that passes a position that divides electrical length L2 of the dipole antenna into halves and extends in a perpendicular direction to the longitudinal direction of the dipole antenna and is provided on a surface of dielectric substrate 101. As shown in FIG. 1, center axis 109 is an axis which passes the center on the X-axis of the dipole antenna in parallel to the +Z-axis direction on dielectric substrate 101.

Center axis 110 of parasitic element group 108 is an axis which is parallel to center axis 109 of the dipole antenna on dielectric substrate 101, and passes approximately a halfway position between a parasitic element 106 disposed at the most +X-axis direction side on the X-axis of parasitic element group 108 and a parasitic element 106 disposed at the most −X-axis direction side on the X-axis of parasitic element group 108. Center axis 110 is a center axis of parasitic element group 108.

In this manner, the dipole antenna and parasitic element group 108 are arranged so that center axis 109 of the dipole antenna and center axis 110 of parasitic element group 108 are at positions that are different from each other on the X-axis. With this configuration, the radio wave radiation direction of antenna device 100 can be tilted in the +X-axis direction or the −X-axis direction from the Z-axis on the ZX plane. As shown in FIG. 1 and FIG. 2, by the arrangement in which center axis 109 of the dipole antenna constituted by dipole element 104 and dipole element 105 is shifted in the +X-axis direction from center axis 110 of parasitic element group 108, a phase lag occurs when a radio wave propagates in the gaps in the −X-axis direction. As a result, the radio wave radiation direction of antenna device 100 tilts in the −X-axis direction.

A result of 3-dimensional electromagnetic wave analysis of antenna device 100 shown in FIG. 1 will be described. Dielectric substrate 101 was a glass epoxy substrate having a thickness of 0.2 mm. The length of dipole element 104 was 0.8 mm, and the length of dipole element 105 was 0.8 mm. Parasitic element array 107 was configured by arranging in the +Z-axis direction sixteen parasitic elements 106 each having a length L3 of 0.4 mm with each distance L4 in the +Z-axis direction of 0.12 mm. Parasitic element group 108 was configured by arranging six columns of parasitic element arrays 107 with each distance L5 in the +X-axis direction of 0.3 mm.

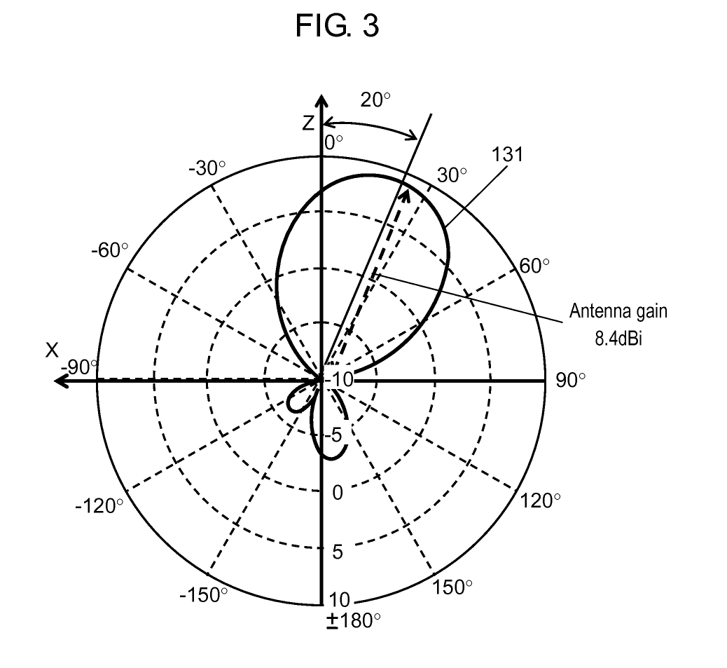

A radiation pattern on the ZX-plane was analyzed in a condition that center axis 109 of the dipole antenna constituted by dipole elements 104 and 105 was shifted by 1.1 mm in the +X-axis direction from center axis 110 of parasitic element group 108. FIG. 3 is a graph showing a radiation pattern of antenna device 100 shown in FIG. 1 on the ZX plane. On the ZX plane, a beam with a high antenna gain of 8.4 dBi is tilted by approximately 20 degrees in the −X-axis direction with respect to the +Z-axis direction.

As a conventional technique to control beam of the diversity system and the like by using parasitic elements and the like, a structure is disclosed in PTL 1, in which waveguides are arranged in a plurality of directions to form a printed dipole antenna having a bi-directional directivity in the horizontal direction of the substrate. However, in order to configure the antenna so as to tilt the beam, the overall structure must be oriented in that direction. Accordingly, the area on the module substrate increases, so that it is difficult to properly dispose the ground conductor. Also, the structure which a plurality of antennas having the same structure are arranged in a desired radiation direction has a problem that the overall antenna size increases.

To cope with these problems, antenna device 100 is configured such that center axis 109 of the dipole antenna and center axis 110 of parasitic element group 108 are disposed at different positions from each other on the X-axis, as described above. With this configuration, the radio wave radiation direction of antenna device 100 can be changed. In this case, it is possible to set the radio wave radiation direction of antenna device 100 to be different from the direction (longitudinal direction) of the waveguide between adjacent two parasitic element arrays 107 on the X-axis. This means that the radio wave radiation direction of antenna device 100 can be changed without changing the direction of the waveguide between parasitic element arrays 107. Accordingly, the antenna size can be made smaller than the conventional techniques.

Incidentally, in the present exemplary embodiment, the description has been given of the example in which six parasitic element arrays 107 each include eleven parasitic elements 106. However, the number of parasitic element arrays and the number of parasitic elements are not limited to these numbers. The number of parasitic element arrays 107 may be at least three.

### Modified Example of First Exemplary Embodiment

In the first exemplary embodiment, the description has been given of the case in which parasitic element group 108 is disposed only on the front surface of the dielectric substrate. However, the present disclosure is not limited to this configuration.

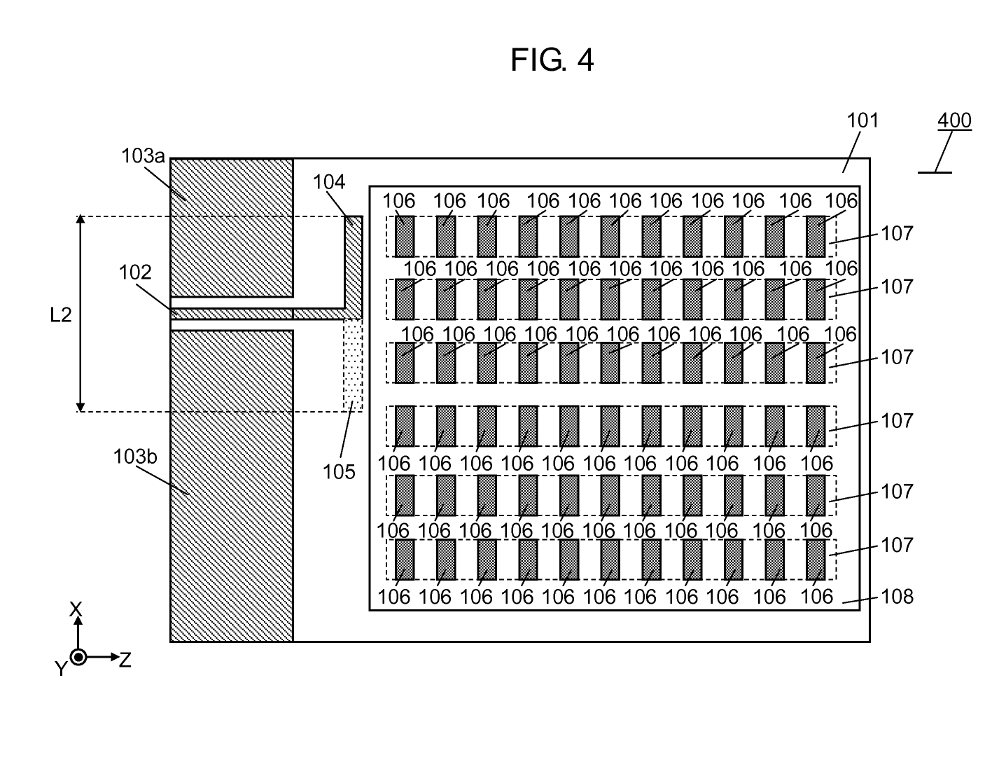

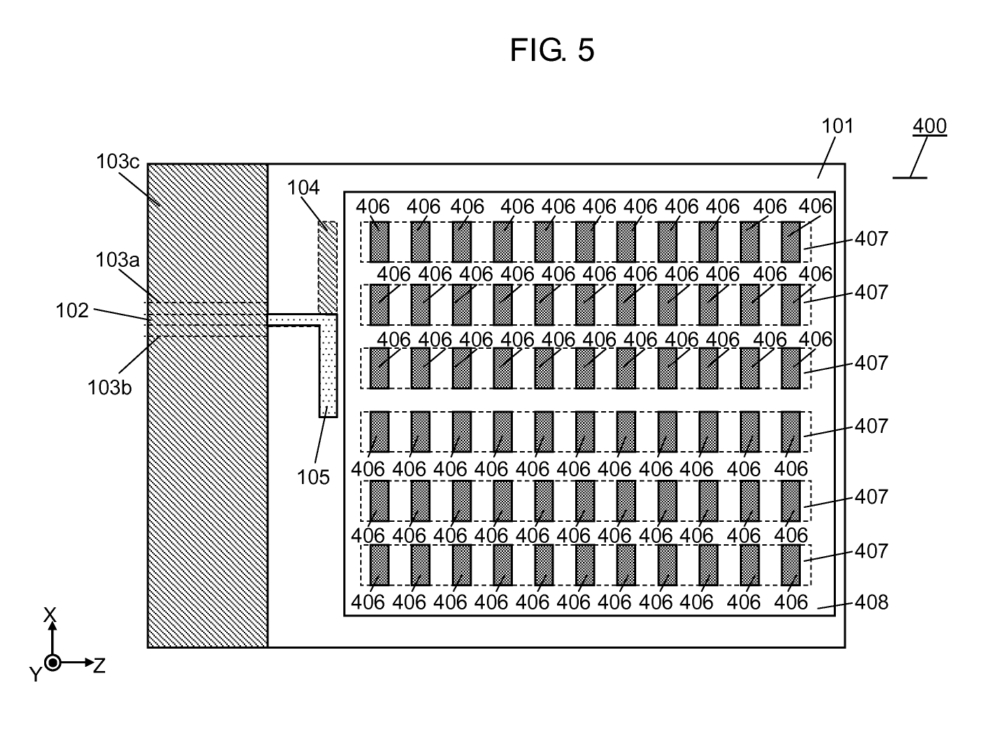

FIG. 4 is a front view of antenna device 400 according to a modified example of the first exemplary embodiment, and FIG. 5 is a back view of antenna device 400 shown in FIG. 4 and is the view from the front surface side. The front surface side has the same configuration as that of antenna device 100, and the back surface side is different from that of antenna device 100. Specifically, in addition to parasitic element group 108 on the front surface, parasitic element group 408 is disposed on the back surface. Parasitic element group 408 is configured to include six parasitic element arrays 407 each including eleven parasitic elements 406.

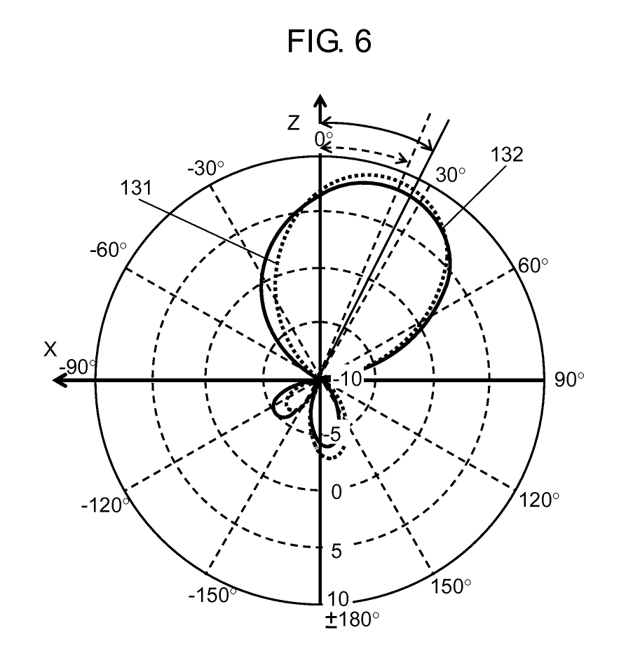

An electromagnetic field analysis was performed in a case where parasitic element group 108 is disposed on the front surface and parasitic element group 408 is disposed on the back surface and the parasitic elements 106 and 406 are the same conditions such as the element lengths. A result of the electromagnetic field analysis is shown in FIG. 6. Referring to FIG. 6, analysis result 131 indicated by broken lines is a result in a case where parasitic element group 108 is disposed only on the front surface (i.e., the same as the analysis result shown in FIG. 3), and analysis result 132 indicated by solid lines is a result in a case where parasitic element groups 108 and 408 are disposed on the both surfaces, respectively. It may be found that the tilt of the electric wave radiation direction of the endfire antenna in the −X-axis direction is slightly larger in analysis result 132 than in analysis result 131, as a result of disposing parasitic element groups 108 and 408 on the both surfaces of dielectric substrate 101, respectively.

Consequently, the radio wave radiation direction of the antenna device can be changed not only by the arrangement of the dipole antenna, but also by disposing the parasitic element groups on both the front and back surfaces of the dielectric substrate.

It has been described in the first exemplary embodiment that the element lengths (the lengths in the longitudinal direction) of dipole element 104 and dipole element 105 are substantially the same. In this case, the dipole antenna operates in a balanced mode. If the element lengths of dipole element 104 and dipole element 105 are made different from each other, distribution of radio frequency current changes between the two elements. The change in the radio frequency current causes the operation of the dipole antenna to be unbalanced. This unbalance causes a tilt of the radiation direction of the dipole antenna on the ZX plane. This can be utilized to adjust the tilt amount of the beam in the radio wave radiation direction of the endfire antenna.

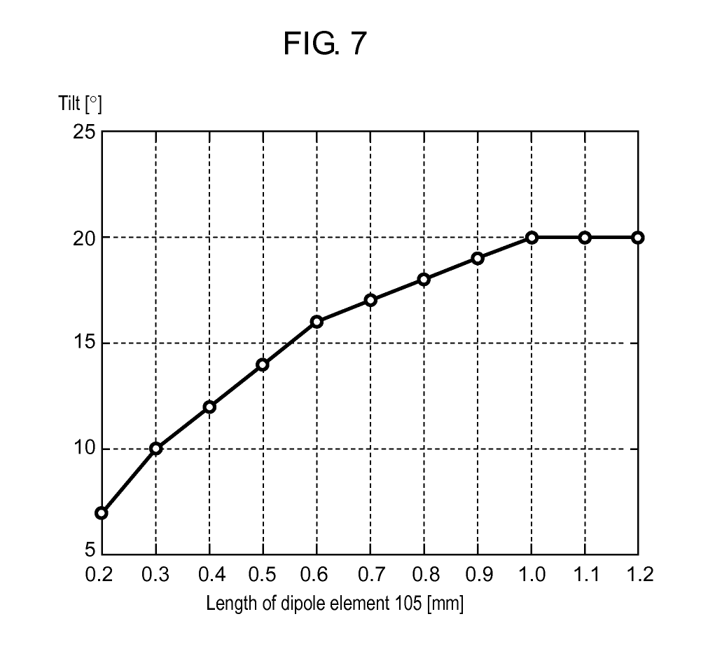

Under the same analyzing conditions as those of the 3 dimensional electromagnetic wave analysis of antenna device 100 shown in FIG. 1, an analysis was made by changing the element length of dipole element 105. Specifically, dielectric substrate 101 was a glass epoxy substrate having a thickness of 0.2 mm. The length of dipole element 104 was made 0.8 mm. Parasitic element array 107 was configured by arranging in the +Z-axis direction sixteen parasitic elements 106 each having length L3 of 0.4 mm at each distance L4 in the +Z-axis direction of 0.12 mm. Parasitic element group 108 was configured by arranging six columns of parasitic element arrays 107 at each distance L5 in the +X-axis direction of 0.3 mm. The length of dipole element 105 was changed in the range from 0.2 mm to 1.0 mm. FIG. 7 is a graph showing a change of a radiation pattern on the ZX plane when changing the length of dipole element 105. The horizontal axis indicates the length of dipole element 105, and the vertical axis indicates the tilt of the radiation pattern on the ZX plane. The tilt of the radiation pattern was about 7° when the element length of dipole element 105 was 0.2 mm, the tilt of the radiation pattern was about 10° when the element length of dipole element 105 was 0.3 mm, the tilt of the radiation pattern was about 12° when the element length of dipole element 105 was 0.4 mm, the tilt of the radiation pattern was about 14° when the element length of dipole element 105 was 0.5 mm, the tilt of the radiation pattern was about 16° when the element length of dipole element 105 was 0.6 mm, the tilt of the radiation pattern was about 17° when the element length of dipole element 105 was 0.7 mm, the tilt of the radiation pattern was about 18° when the element length of dipole element 105 was 0.8 mm, the tilt of the radiation pattern was about 19° when the element length of dipole element 105 was 0.9 mm, the tilt of the radiation pattern was about 20° when the element length of dipole element 105 was 1.0 mm. It can be understood from this result that the tilt amount of the radiation pattern on the ZX plane increases with the increase of the element length of dipole element 105.

As described above, the tilt amount of the radiation direction of antenna device 100 on the horizontal plane (the ZX plane) can be changed by changing the positional relationship between the center axis of the dipole antenna constituted by dipole elements 104 and 105 and the center axis of parasitic element group 108, or by changing the difference between the element lengths of dipole elements 104 and 105.

### Second Exemplary Embodiment

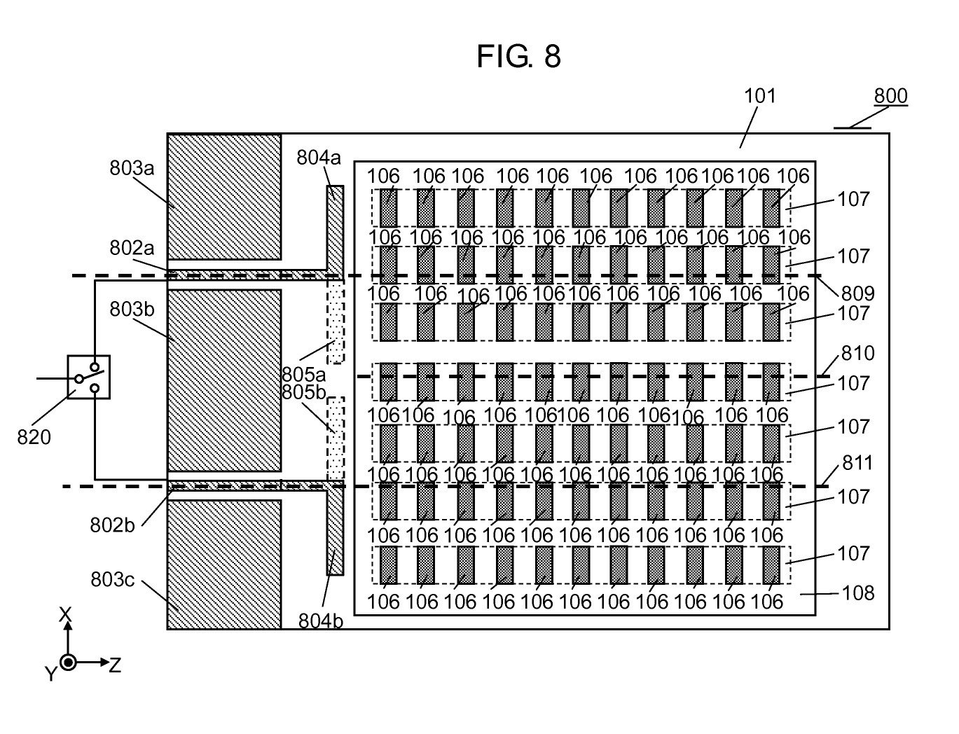

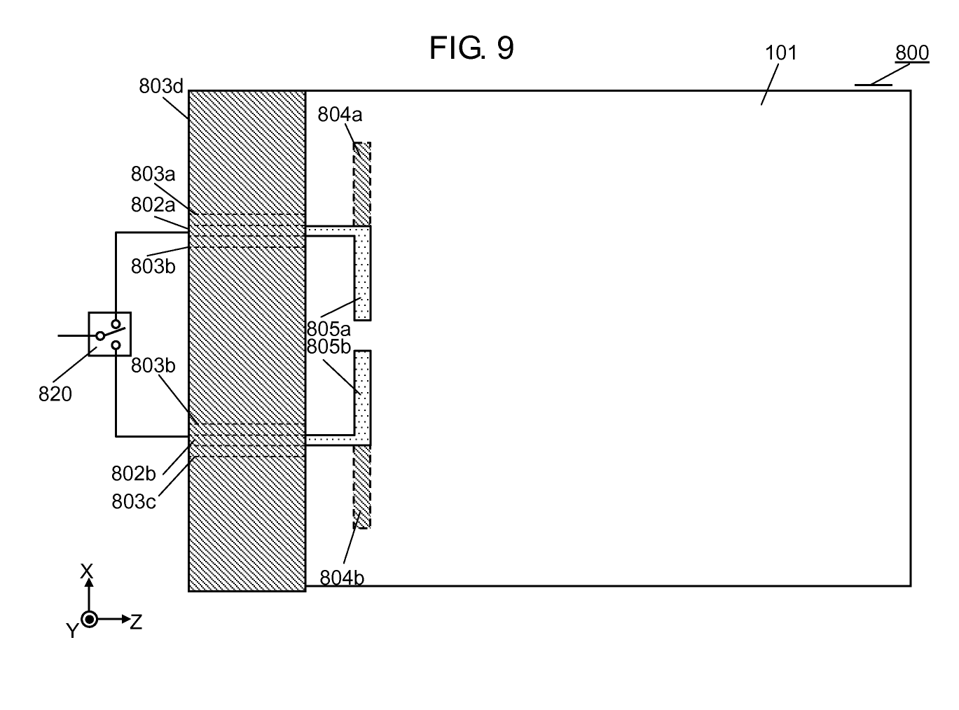

A second exemplary embodiment will be described with reference to from FIG. 8 to FIG. 11. FIG. 8 is a front view of antenna device 800 according to the present exemplary embodiment, and FIG. 9 is a back view of antenna device 800 in FIG. 8 and is the view from the front surface side. Antenna device 800 according to the present exemplary embodiment is an endfire antenna for a wireless communication device that performs wireless communication in a radio frequency band such as the millimeter wave band.

The following description will be given mainly of parts that are different from the first exemplary embodiment. The same parts as those of the first exemplary embodiment are assigned with the same reference marks as those of the first exemplary embodiment, and description on them will be omitted.

Referring to FIG. 8 and FIG. 9, differences from the first exemplary embodiment are that antenna device 800 includes ground conductors 803a, 803b, 803c and 803d, feed lines 802a and 802b, and dipole elements 804a, 804b, 805a and 805b, and further has switching element 820. Ground conductors 803a, 803b and 803c, feed lines 802a and 802b, dipole elements 804a and 804b, parasitic elements 106, parasitic element arrays 107 and parasitic element group 108 are formed on the front surface of dielectric substrate 101. Ground conductor 803d and dipole elements 805a and 805b are formed on the back surface of dielectric substrate 101. Ground conductor 803d is formed on the left end of dielectric substrate 101 in FIG. 8. Feed lines 802a and 802b are formed so as to oppose to ground conductor 803d and to extend in the +Z-axis direction from the left end of dielectric substrate 101. Ground conductors 803a and 803b are formed on both sides of feed line 802a with a predetermined interval from feed line 802a so as to oppose to ground conductor 803d, and ground conductors 803b and 803c are formed on both sides of feed line 802b with a predetermined interval from feed line 802b so as to oppose to ground conductor 803d. Ground conductors 803a, 803b, 803c and 803d are electrically connected to one another.

Referring to FIG. 8 and FIG. 9, ground conductors 803a and 803b, feed line 802a and ground conductor 803d configure a grounded coplanar waveguide used as a power supply line. Also, ground conductors 803b, 803c and 803d and feed line 802b configure a grounded coplanar waveguide used as a power supply line.

Feed line 802a is a line that supplies a radio frequency signal from switching element 820 to dipole element 804a. Feed line 802b is a line that supplies a radio frequency signal from switching element 820 to dipole element 804b.

Dipole element 804a and dipole element 805a configure a first dipole antenna. This is the same configuration as that of the dipole antenna configured by dipole elements 104 and 105 described in the first exemplary embodiment.

Also, dipole element 804b and dipole element 805b configure a second dipole antenna.

Switching element 820 is a switch that exclusively selects either supply of a radio frequency signal to the first dipole antenna or supply of the radio frequency signal to the second dipole antenna.

Center axis 809 of the first dipole antenna is disposed at a different position on the X-axis from a position of center axis 810 of parasitic element group 108 in the same manner as the first exemplary embodiment. Specifically, the position of center axis 809 of the first dipole antenna is shifted in the +X-axis direction from the position of center axis 810 of parasitic element group 108. On the other hand, the position of center axis 811 of the second dipole antenna is shifted in the −X-axis direction from the position of center axis 810 of parasitic element group 108. Antenna device 800 shown in FIG. 8 is configured such that the distance on the X-axis between center axis 810 and center axis 809 is the same as the distance on the X-axis between center axis 810 and center axis 811.

However, the distance on the X-axis between center axis 810 and center axis 809 may not be the same as the distance on the X-axis between center axis 810 and center axis 811.

When switching element 820 is connected to feed line 802a, the radio frequency signal is supplied to dipole elements 804a and 805a. Dipole element 804a and dipole element 805a are excited by the radio frequency signal. An electromagnetic field radiated from the first dipole antenna is guided in a gap, which is a waveguide, between adjacent two parasitic element arrays 107 in the +Z-axis direction, and radiated from the right end of dielectric substrate 101 in the +Z-axis direction, which is the directivity direction of the endfire antenna. The radiation directivity on the ZX plane tilts in the −X-axis direction with respect to the Z-axis.

When switching element 820 is connected to feed line 802b, the radio frequency signal is supplied to dipole elements 804b and 805b. Dipole element 804b and dipole element 805b are excited by the radio frequency signal, guided in the gap, which is the waveguide, between adjacent two parasitic element arrays 107, and radiated from the right end of dielectric substrate 101 in the +Z-axis direction. The radiation directivity on the ZX plane tilts in the +X-axis direction with respect to the Z-axis.

That is, parasitic element group 108, the first dipole antenna and the second dipole antenna are arranged such that center axis 809 of the first dipole antenna and center axis 811 of the second dipole antenna are disposed at positions shifted in one direction (the +X-axis direction) and in the opposite direction (the −X-axis direction), respectively, with respect to center axis 810 of parasitic element group 108. Further, it becomes possible to change the directivity of the radio wave radiated from antenna device 800 by exclusively switching supply of a radio frequency signal to the first dipole antenna and supply of the radio frequency signal to the second dipole antenna. In either case of selecting the first dipole antenna or selecting the second dipole antenna, the radio wave radiation direction is tilted by utilizing unevenness (phase lag) of the electromagnetic field propagating through the waveguide between adjacent two parasitic element arrays 107 as described in the first exemplary embodiment.

As described above, antenna device 800 described in the present exemplary embodiment can produce two kinds of radiation directivities in the condition that two dipole antennas share parasitic element group 108.

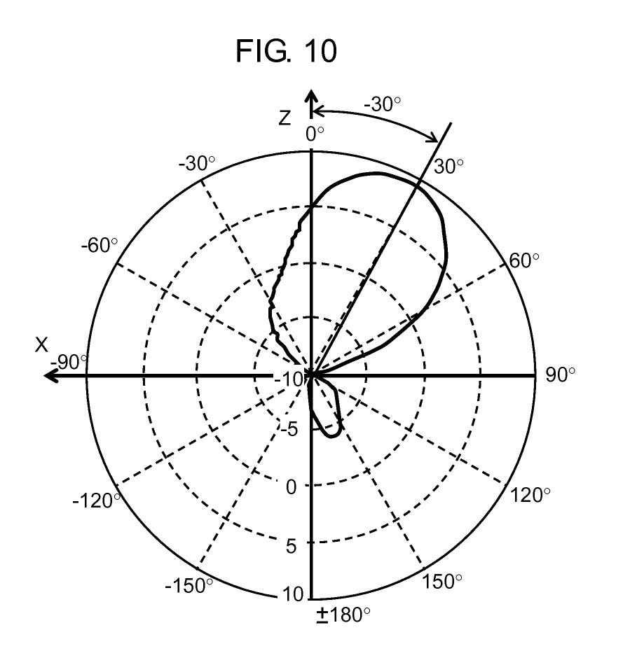

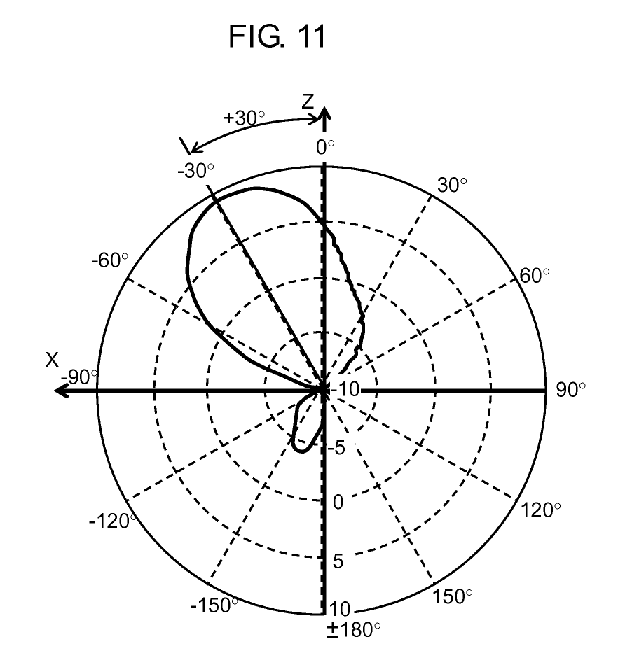

As an example, a 3-dimensional electromagnetic field analysis was performed by setting the length of each of dipole element 805a and dipole element 805b to be 0.9 mm, the number of columns of parasitic element arrays 107 to be seven, and the other parameters to be in the same conditions as those of antenna device 100 of the first exemplary embodiment shown in FIG. 1. Results of this analysis are shown in FIG. 10 and FIG. 11.

Here, in antenna device 800 used for the 3-dimensional electromagnetic field analysis, center axis 809 of the first dipole antenna and center axis 811 of the second dipole antenna are disposed at symmetrical positions on the X-axis with respect to center axis 810 of parasitic element group 108.

FIG. 10 is a graph showing a radiation pattern on the ZX plane when the first dipole antenna is fed in antenna device 800 shown in FIG. 8. FIG. 11 is a graph showing a radiation pattern on the ZX plane when the second dipole antenna is fed in antenna device 800 shown in FIG. 8.

FIG. 10 shows a radiation directivity of antenna device 800 when switching element 820 is connected to feed line 802a. FIG. 11 shows a radiation directivity of antenna device 800 when switching element 820 is connected to feed line 802b. The radiation directions are the −30 degree angle and +30 degree angle directions, respectively. Half-power beamwidths of the radiation patterns of the first dipole antenna and the second dipole antenna are approximately a little narrower than −60 degrees and a little narrower than +60 degrees, respectively. Accordingly, when radio communication is performed by the diversity system that switches the radiations of the first dipole antenna and the second dipole antenna, a total half-power beamwidth of approximately 100 degrees on the ZX plane can be obtained, so that the communication range can be expanded.

### Third Exemplary Embodiment

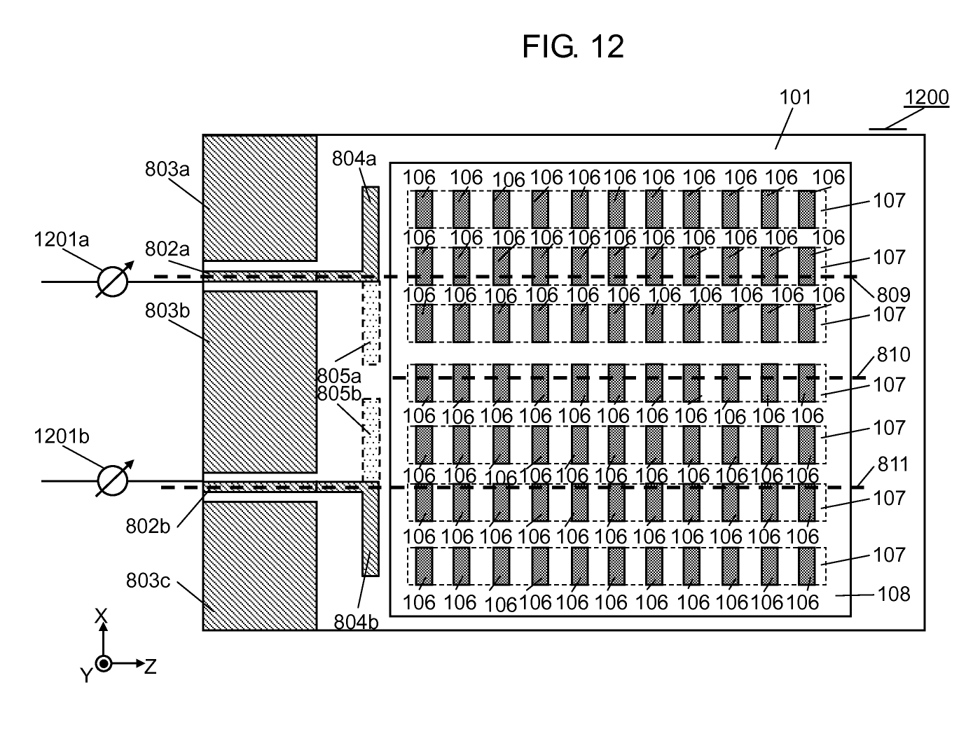

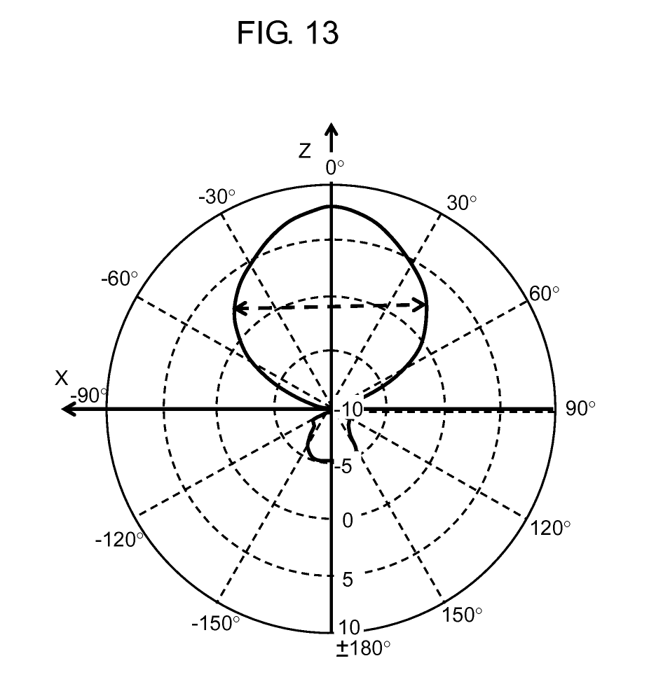

A third exemplary embodiment will be described with reference to from FIG. 12 and FIG. 13. FIG. 12 is a front view of antenna device 1200 of 2-element variable phase shift type according to the present exemplary embodiment.

In the present embodiment, description will be focused on points that are different from the second exemplary embodiment. The same parts as those of the second exemplary embodiment are assigned with the same reference marks as those of the second exemplary embodiment, and description on them will be omitted.

Referring to FIG. 12, a difference from FIG. 8 described in the second exemplary embodiment is that variable phase shifters 1201a and 1201b are provided in place of switching element 820.

Each of variable phase shifters 1201a and 1201b receives a radio frequency signal, shifts the phase of the radio frequency signal, and outputs the phase-shifted radio frequency signal. Variable phase shifters 1201a and 1201b shift the phases of radio frequency signals which are supplied to feed lines 802a and 802b, respectively. For example, with respect to radio frequency signals input to variable phase shifters 1201a and 1201b, variable phase shifters 1201a and 1201b delays the input radio frequency signals by predetermined times to output radio frequency signals which are supplied to feed lines 802a and 802b, respectively. The delay operations cause the radio frequency signals output from variable phase shifters 1201a and 1201b to be different in phase by the delayed amounts from the radio frequency signals input to variable phase shifters 1201a and 1201b, respectively. Variable phase shifters 1201a and 1201b variably set the phase lag amount.

In antenna device 1200 shown in FIG. 12, center axis 809 of the first dipole antenna is disposed at a position shifted in the +X-axis direction from center axis 810 of parasitic element group 108. On the other hand, the position of center axis 811 of the second dipole antenna is shifted in the −X-axis direction from the position of center axis 810 of parasitic element group 108. Antenna device 1200 is configured such that the distance on the X-axis between center axis 810 and center axis 809 is the same as the distance on the X-axis between center axis 810 and center axis 811.

Now, description will be given of a case where radio frequency signals which are opposite in phase to each other (±180 degrees) are supplied from variable phase shifters 1201a and 1201b.

As an example, an electromagnetic field analysis of the radiation directivity on the ZX plane was performed by using the same parameters as those of the second exemplary embodiment, in a case where radio frequency signals are fed to variable phase shifters 1201a and 1201b so that radio frequency signals which are opposite in phase to each other are supplied to feed lines 802a and 802b. A result of the electromagnetic field analysis is shown in FIG. 13. FIG. 13 is a graph showing a radiation pattern on the ZX plane, when the phase difference between feed to the first dipole antenna and feed to the second dipole antenna is ±180 degrees in antenna device 1200 shown in FIG. 12.

Referring to FIG. 13, the radiation direction of antenna device 1200 is on the Z-axis, and in the front direction. The reason is as follows. As described in the second exemplary embodiment, the radiation direction of each element factor when it is individually fed tilts as shown in FIG. 10 and FIG. 11. Further, the tilt directions are opposite to each other. Accordingly, in the case of antenna device 1200 having variable phase shifters 1201a and 1201b as shown in FIG. 12 according to the present exemplary embodiment, the operation as an antenna array allows the radiation directivity on the ZX plane shown in FIG. 13 to have a wider beamwidth than the antenna devices of the above-described first and second exemplary embodiments. Also, the directivity of the overall antenna is in the front direction (on the Z-axis).

As described above in the present exemplary embodiment, it is possible to realize an antenna device that has a radiation directivity in the +Z-axis direction and also has a wider radiation range (beamwidth) than the antenna devices of the above-described first and second exemplary embodiments, by coinstantaneously applying radio frequency signals to the first dipole antenna and the second dipole antenna in such a condition that the phases of the radio frequency signals are opposite to each other.

### Modified Example of Third Exemplary Embodiment

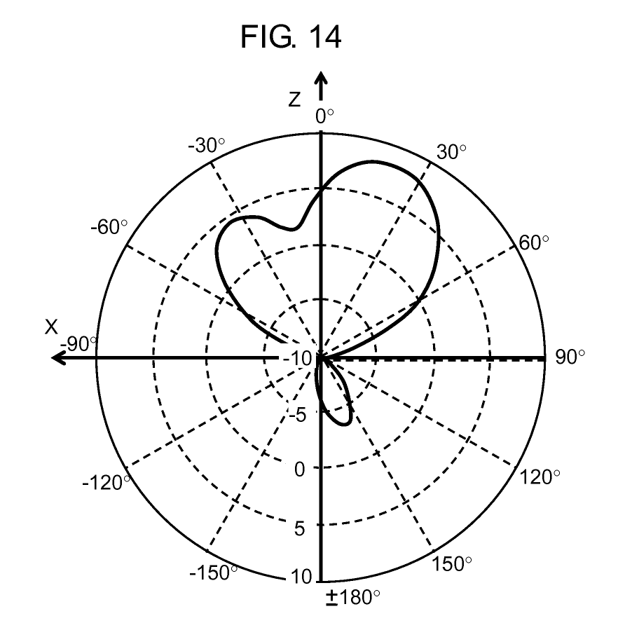

In the third exemplary embodiment, such antenna device 1200 has been described that uses variable phase shifters 1201a and 1201b each being capable of variably changing the phase. However, regarding the case described in the third exemplary embodiment, it is not necessary to variably change the phase. A description will be given of a case where the phase difference between the radio frequency signals fed to feed lines 802a and 802b is fixed to 90 degrees. More specifically, a description will be given of a case where the phase of the radio frequency signal supplied to the second dipole antenna is shifted to lag by 90 degrees from that of the radio frequency signal supplied to the first dipole antenna. FIG. 14 is a graph showing a radiation pattern on the ZX plane, when the phase difference between feed to the first dipole antenna and feed to the second dipole antenna is fixed to 90 degrees in antenna device 1200 shown in FIG. 12. Compared to the second exemplary embodiment, in which the radio frequency signals are exclusively controlled, the radiation characteristic of antenna device 1200 can be tilted with respect to the Z-axis, so that radio communication in the diversity system becomes possible.

The antenna device in this modified example can be realized by making a radio frequency signal input to one of two input feed lines (the second dipole antenna) to lag by a fixed phase amount with respect to a radio frequency signal input to the other of the two input feed lines (the first dipole antenna). Accordingly, a single variable phase shifter may be provided at only one of the two inputs.

### Fourth Exemplary Embodiment

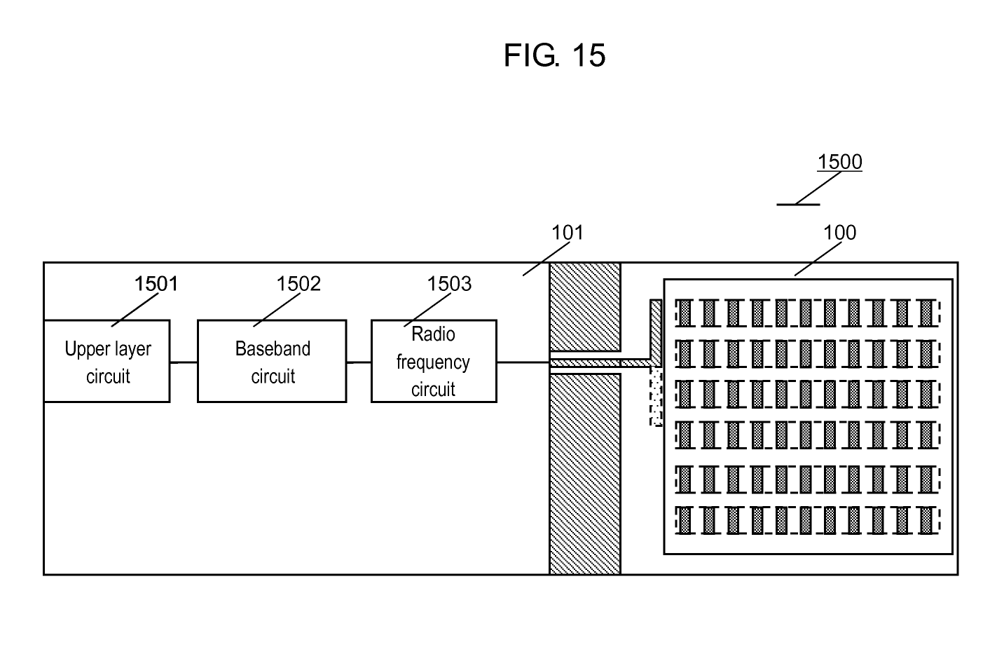

FIG. 15 is a front view of wireless communication device 1500 according to a fourth exemplary embodiment. Referring to FIG. 15, wireless communication device 1500 is a wireless communication device such, as a wireless module substrate, and is configured by including antenna device 100 according to the first exemplary embodiment, upper layer circuit 1501, baseband circuit 1502, and radio frequency circuit 1503. Here, upper layer circuit 1501, baseband circuit 1502 and radio frequency circuit 1503 are formed on the front surface of dielectric substrate 101. Upper layer circuit 1501, baseband circuit 1502 and radio frequency circuit 1503 are disposed on the side in the −Z-axis direction with respect to the dipole antenna of antenna device 100.

Referring to FIG. 15, upper layer circuit 1501 is a circuit which is in a upper layer than the physical layer such as a media access control (MAC) layer and an application layer, and includes, for example, a communication circuit and a host processing circuit. Upper layer circuit 1501 outputs a specific data signal to baseband circuit 1502, and, on the other hand, performs a predetermined signal processing of a baseband signal from baseband circuit 1502 to convert the baseband signal to a data signal. Baseband circuit 1502 performs a waveform shaping processing of the data signal from upper layer circuit 1501, then modulates a specified carrier wave signal with the waveform-shaped data signal to convert the data signal to a radio frequency signal, and outputs the radio frequency signal to radio frequency circuit 1503. Also, baseband circuit 1502 demodulates a radio frequency signal from radio frequency circuit 1503 into a baseband signal, and outputs the demodulated signal to upper layer circuit 1501.

Also, referring to FIG. 15, radio frequency circuit 1503 performs a power amplifying processing and a waveform shaping processing in a radio frequency band of the radio frequency signal from baseband circuit 1502, and outputs the processed radio frequency signal to the dipole antenna through feed line 102. Also, radio frequency circuit 1503 performs a predetermined processing such, for example, as a frequency conversion of a radio frequency signal wirelessly received by the dipole antenna, and outputs the processed signal to baseband circuit 1502.

Incidentally, radio frequency circuit 1503 and antenna device 100 are connected to each other through a radio frequency transmission line. Also, an impedance matching circuit may be provided between radio frequency circuit 1503 and antenna device 100 as necessary.

Since wireless communication device 1500 configured as described above performs wireless transmission and reception of a radio frequency signal by using antenna device 100, it is possible to realize a wireless communication device that has a smaller size and a higher gain than the conventional devices.

Incidentally, although wireless communication device 1500 according to the present exemplary embodiment has antenna device 100, the present invention is not limited to this configuration. The wireless communication device may have antenna device 400, 800 or 1200.

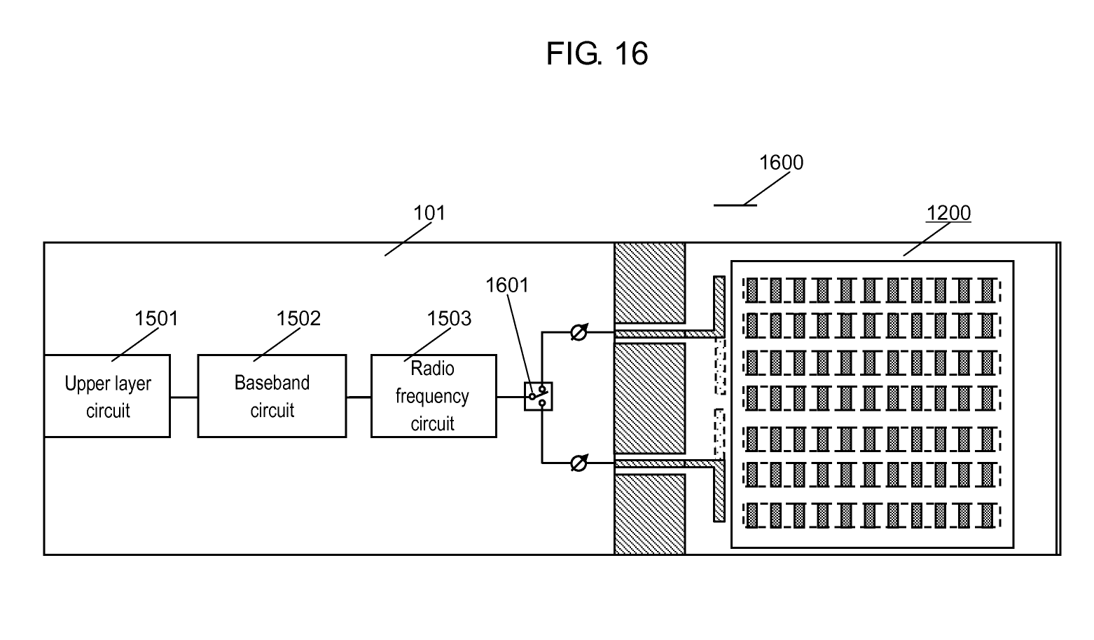

FIG. 16 is a front view showing wireless communication device 1600 according to the present exemplary embodiment. This device is different from wireless communication device 1500 shown in FIG. 15 in that antenna device 1200 is provided in place of antenna device 100, and that switch 1601 is provided between radio frequency circuit 1503 and antenna device 1200.

Wireless communication device 1600 provided with antenna device 1200 feeds, as an initial operation, powers of frequency signals with opposite phases to each other to feed lines 802a and 802b. This allows the radiation characteristic of wireless communication device 1600 to form a wide-width beam in the wave-guiding, front direction as described in conjunction with FIG. 13. Wireless communication device 1600 searches a communication partner in this state. Next, communication device 1600 finds a communication partner, and performs a predetermined connecting process. After having completed the connecting process, communication device 1600 enables only the circuit connected to only one of feed lines 802a and 802b to be effective to perform a data communication. To enable the circuit connected to either one of feed lines 802a and 802b, switch 1601 which controls validation/invalidation of the input of the radio frequency signal may be provided between antenna device 1200 and radio frequency circuit 1503. Wireless communication device 1600 transmits and receives a radio wave having the radiation directivity tilted in the +X-axis direction or in the −X-axis direction from the Z-axis as shown in FIG. 10 and FIG. 11, to point the radiation direction to the direction in which the communication partner is located.

With this configuration, it is possible to realize a communication with each of communication partners located over a wider area at a high carrier to noise ratio (CNR).

Also, although wireless communication devices 1500 and 1600 according to the present exemplary embodiment have been described as devices that perform both wireless transmission and wireless reception, they are not limited to such configurations, and may be configured to perform only wireless transmission or only wireless reception.

Also, the description has been given of the example in which, as a switch for controlling validation/invalidation of the radio frequency signal input, switch 1601 for controlling validation/invalidation of the radio frequency signal input is provided between antenna device 1200 and radio frequency circuit 1503. As an alternative, separate switches may be provided between variable phase shifter 1201a and feed line 802a of antenna device 1200 and between variable phase shifter 1201b and feed line 802b of antenna device 1200, respectively.

### SUMMARY

The present disclosure provides the following configuration. An antenna device includes a dielectric substrate having a first surface and a second surface, a first dipole antenna including a first dipole element formed on the first surface of the dielectric substrate and connected to a first feed line, and a second dipole element formed on the second surface of the dielectric substrate and connected to a ground conductor, and a first parasitic element group including a plurality of first parasitic element arrays, each of the first parasitic element arrays including a plurality of first parasitic elements formed on the first surface of the dielectric substrate. Each of the plurality of first parasitic elements has a strip shape substantially parallel to a longitudinal direction of the first dipole antenna, and is electromagnetically coupled to another of the plurality of first parasitic elements, the plurality of first parasitic element arrays are arranged substantially parallel to one another, and a gap is formed between each adjacent two of the plurality of first parasitic element arrays, and a center axis of the first dipole antenna and a center axis of the first parasitic element group are disposed so as not to overlap, the center axis of the first dipole antenna is an axis which extends a center of an electrical length of the first dipole antenna to a wave-guiding direction of a radio frequency signal and the center axis of the first parasitic element group is an axis which extends a center of a longitudinal direction of the first dipole antenna in the first parasitic element group to a wave-guiding direction of the radio frequency signal.

With this configuration, the above-described antenna device can have a radiation characteristic that is tilted in either one of longitudinal directions of the first dipole element from a direction that is parallel to a center axis of the first dipole element.

In the above-described antenna device, a length of the first dipole element may be different from a length of the second dipole element. In the case that the length of the first dipole element and the length of the second dipole element are different from each other, it is possible to tilt the radiation characteristic of a radio wave primarily radiated by the first dipole element.

With this configuration, it is possible to tilt the radiation directivity of the antenna device in the same way as that described above.

Further, it is preferable that the above-described antenna device may further has a second dipole antenna including a third dipole element formed on the first surface of the dielectric substrate and connected to a second feed line, and a fourth dipole element formed on the second surface of the dielectric substrate and connected to the ground conductor, wherein the longitudinal direction of the first dipole antenna and a longitudinal direction of the second dipole antenna are substantially parallel to each other, and a center axis of the first dipole antenna and a center axis of the second dipole antenna are disposed so as not to overlap, the center axis of the first dipole antenna is an axis which extends a center of an electrical length of the first dipole antenna to the wave-guiding direction of the radio frequency signal and a center axis of the second dipole antenna extends a center of an electrical length of the second dipole antenna to the wave-guiding direction of the radio frequency signal.

Further, the above-described antenna device may be configured so that feeding is exclusively switched between the first dipole antenna and the second dipole antenna.

Further, the above-described antenna device may be configured such that the first dipole antenna and the second dipole antenna are with frequency signals of different phases.

Further, the above-described antenna device may be configured to further include a second parasitic element group including a plurality of second parasitic element arrays, each of the second parasitic element arrays including a plurality of second parasitic elements formed on the second surface of the dielectric substrate, each of the plurality of second parasitic elements has a strip shape substantially parallel to a longitudinal direction of the first dipole antenna, and is electromagnetically couple to another of the plurality of second parasitic elements, and the plurality of second parasitic element arrays are arranged substantially parallel to one another, and a gap is formed between each adjacent two of the plurality of second parasitic element arrays.

With this configuration, it is possible to produce two kinds of radiation directivities in the condition that two dipole antennas share parasitic element groups.

### Other Exemplary Embodiments

In the above, the first to fourth exemplary embodiments have been described as examples of techniques to be disclosed. However, the techniques according to the present disclosure are not limited to these, and may be applied to other exemplary embodiments in which modifications, substitutions, additions or omissions are appropriately made. Further, components described in the first to fourth exemplary embodiments described above may be combined to configure a new exemplary embodiment.

As the above, the exemplary embodiments have been described as examples of techniques according to the present disclosure. The detailed description and accompanying drawings have been provided for that purpose.

Accordingly, components shown in the accompanying drawings and described in the detailed description include not only components that are essential to solve the problems, but also components that are not essential to solve the problems, but are used to exemplify the above-mentioned techniques. Therefore, those non-essential components should not be immediately construed as essential for the reason that the non-essential components are shown in the accompanying drawings or described in the detailed description.

Also, since the above-described embodiments are to exemplify the techniques according to the present disclosure, various modifications, substitutions, additions or omissions may be possible within the scope of the claims or equivalents thereof.

### INDUSTRIAL APPLICABILITY

The antenna device according to the present disclosure and the wireless communication device using the antenna device can be effectively used in the field of radio frequency communications and the like.

### REFERENCE MARKS IN THE DRAWINGS

100, 400, 800, 1200: antenna device
101: dielectric substrate
102, 802a, 802b: feed line
103a, 103b, 103c, 803a, 803b, 803c, 803d: ground conductor
104, 804a, 804b, 105, 805a, 805b: dipole element
106, 406: parasitic element
107, 407: parasitic element array
108, 408: parasitic element group
109, 110, 809, 810, 811: center axis
820: switching element
1201a, 1201b: variable phase shifter
1500, 1600: wireless communication device
1501: upper layer circuit
1502: baseband circuit
1503: radio frequency circuit
1601: switch

1. An antenna device comprising:
a dielectric substrate having a first surface and a second surface;
a first dipole antenna including a first dipole element formed on the first surface of the dielectric substrate and connected to a first feed line, and a second dipole element formed on the second surface of the dielectric substrate and connected to a ground conductor; and
a first parasitic element group including a plurality of first parasitic element arrays, each of the first parasitic element arrays including a plurality of first parasitic elements formed on the first surface of the dielectric substrate,
wherein each of the plurality of first parasitic elements has a strip shape substantially parallel to a longitudinal direction of the first dipole antenna, and is electromagnetically coupled to another of the plurality of first parasitic elements,
wherein the plurality of first parasitic element arrays are arranged substantially parallel to one another, and a gap is formed between each adjacent two of the plurality of first parasitic element arrays, and
wherein a center axis of the first dipole antenna and a center axis of the first parasitic element group are disposed so as not to overlap, the center axis of the first dipole antenna is an axis which extends a center of an electrical length of the first dipole antenna to a wave-guiding direction of a radio frequency signal, and the center axis of the first parasitic element group is an axis which extends a center of a longitudinal direction of the first dipole antenna in the first parasitic element group to a wave-guiding direction of the radio frequency signal.

2. The antenna device according to claim 1, wherein a length of the first dipole element is different from a length of the second dipole element.

3. The antenna device according to claim 1, further comprising a second dipole antenna including a third dipole element formed on the first surface of the dielectric substrate and connected to a second feed line, and a fourth dipole element formed on the second surface of the dielectric substrate and connected to the ground conductor,
wherein the longitudinal direction of the first dipole antenna and a longitudinal direction of the second dipole antenna are substantially parallel to each other, and
wherein a center axis of the first dipole antenna and a center axis of the second dipole antenna are disposed so as not to overlap, the center axis of the first dipole antenna is an axis which extends a center of an electrical length of the first dipole antenna to the wave-guiding direction of the radio frequency signal and a center axis of the second dipole antenna extends a center of an electrical length of the second dipole antenna to the wave-guiding direction of the radio frequency signal.

4. The antenna device according to claim 3, wherein feeding is exclusively switched between the first dipole antenna and the second dipole antenna.

5. The antenna device according to claim 3, wherein the first dipole antenna and the second dipole antenna are fed with frequency signals of different phases.

6. The antenna device according to claim 1, further comprising a second parasitic element group including a plurality of second parasitic element arrays, each of the second parasitic element arrays including a plurality of second parasitic elements formed on the second surface of the dielectric substrate,
wherein each of the plurality of second parasitic elements has a strip shape substantially parallel to a longitudinal direction of the first dipole antenna, and is electromagnetically couple to another of the plurality of second parasitic elements, and
wherein the plurality of second parasitic element arrays are arranged substantially parallel to one another, and a gap is formed between each adjacent two of the plurality of second parasitic element arrays.

7. A wireless communication device comprising the antenna device according to claim 1.
